(19) United States
(12) Patent Application Publication
(10) Pub. No.: US 2012/0024635 A1
(43) Pub. Date: Feb. 2, 2012

(54) BILL RECEIVING APPARATUS AND SELF-CHECKOUT APPARATUS

(75) Inventor: Toshihiro Kaneko, Shizuoka-ken (JP)

(73) Assignee: TOSHIBA TEC KABUSHIKI KAISHA, Tokyo (JP)

(21) Appl. No.: 13/188,597

(22) Filed: Jul. 22, 2011

(30) Foreign Application Priority Data
Jul. 30, 2010 (JP) 2010-172129

(51) Int. Cl. G07F 7/04; A47F 9/04; G07F 5/02

(52) U.S. Cl. 186/59; 194/206

(57) ABSTRACT

In one embodiment, a bill receiving apparatus includes a housing, a passage forming member, and a conveying unit. The passage forming member forms a bill passage including a vertically-long slit-like opening and a bottom surface formed as a slope, a part of which falls toward the opening. The conveying unit is provided on the inner side of the housing and conveys a bill via the bill passage.

### CROSS-REFERENCE TO RELATED APPLICATIONS

This application is based upon and claims the benefit of priority from Japanese Patent Application No. 2010-172129, filed on Jul. 30, 2010, the entire contents of which are incorporated herein by reference.

### FIELD

Embodiments described herein relate generally to a bill receiving apparatus and a self-checkout apparatus.

### BACKGROUND

In an apparatus that receives bills, a slit-like bill passage is provided in a housing. The bill passage could be arranged in a vertically-long state because of a layout of various units.

If the bill passage is arranged in the vertically-long state, an unaccustomed user is likely to misrecognize that the bill passage is a coin slot.

In order to guide a bill, which tends to curve in the thickness direction, to the inside of the bill passage, in general, the bill passage is formed such that opening width corresponding to the thickness of the bill is larger than the inside of the bill passage near an inlet of the bill passage. In other words, if the bill passage is arranged in the vertically-long state, the opening width near the inlet of the bill passage is expanded in the horizontal direction. The bill passage configured in this way rather facilitates misinsertion of coins.

Under such circumstances, it is desired that, even if a coin is misinserted into the bill passage, the coin can be prevented from entering the inside of the apparatus.

### BRIEF DESCRIPTION OF THE DRAWINGS

FIG. 1 is a perspective view of a self-checkout apparatus according to an embodiment;

FIG. 2 is a block diagram of the self-checkout apparatus according to the embodiment;

FIG. 3 is an enlarged perspective view of a part of a main body shown in FIG. 1;

FIG. 4 is a sectional view of the part of the main body shown in FIG. 2; and

FIG. 5 is a sectional view of a modified configuration example of the part of the main body shown in FIG. 2.

### DETAILED DESCRIPTION

In general, according to one embodiment, a bill receiving apparatus includes a housing, a passage forming member, and a conveying unit. The passage forming member forms a bill passage including a vertically-long slit-like opening and a bottom surface formed as a slope, a part of which falls toward the opening. The conveying unit is provided on the inner side of the housing and conveys a bill via the bill passage.

An embodiment is explained below with reference to the accompanying drawings.

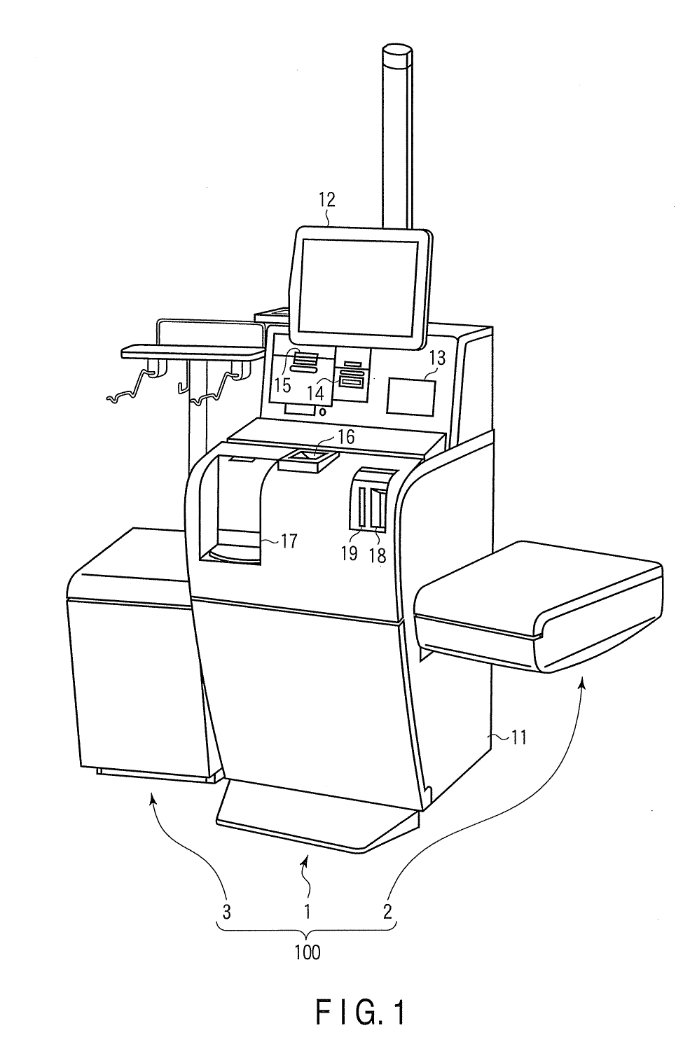

FIG. 1 is a perspective view of a self-checkout apparatus 100 according to this embodiment. The self-checkout apparatus according to this embodiment is also called a point of sale (POS) terminal apparatus of a self-checkout type or a self-register apparatus.

The apparatus 100 includes a main body 1 and commodity tables 2 and 3.

The main body 1 includes a housing 11, a display 12, a scanner window 13, and forming members 14, 15, 16, 17, 18, and 19.

The housing 11 is configured by combining members, each of which is formed of a metal material or a resin material.

The display 12 is fixed in an upper part of the housing 11. The display 12 displays an arbitrary image. As the display 12, for example, a liquid crystal display device can be used. In some cases, a touch sensor is provided over a display screen of the display 12. The display 12 appropriately displays images respectively showing various screens. Examples of the various screens include a screen for informing a customer of an operation method, a screen for inputting information concerning a commodity not affixed with a barcode, a screen showing information based on barcode reading, and a screen showing a total purchase amount, a deposit amount, a change amount, and the like in payment work for paying a purchase price.

The scanner window 13 is formed by covering an opening formed in the housing 11 with transparent resin, glass, or the like. The scanner window 13 radiates, to the outside of the housing 11, light emitted from a scanner arranged on the inside of the housing 11 and leads the light reflected on a commodity to the scanner.

Each of the forming members 14 to 19 is formed of a metal material or a resin material and attached to the housing 11. The forming member 14 forms a card insertion slot for inserting a card such as a credit card into the inside of the housing 11. The forming member 15 forms a receipt issue slot for discharging a receipt to the outside of the housing 11. The forming member 16 forms a coin insertion slot for inserting a coin into the inside of the housing 11. The forming member 17 forms a coin discharge slot for discharging a coin to the outside of the housing 11. The forming member 18 forms a bill insertion slot for inserting a bill into the inside of the housing 11. The forming member 19 forms a bill discharge slot for discharging a bill to the outside of the housing 11. The forming members 14 to 19 may be formed of a single member or may be formed by combining plural members.

The commodity table 2 is a table for placing unregistered commodities and fixed to a side surface of the housing 11.

The commodity table 3 is a table for placing registered commodities and set side by side with the housing 11.

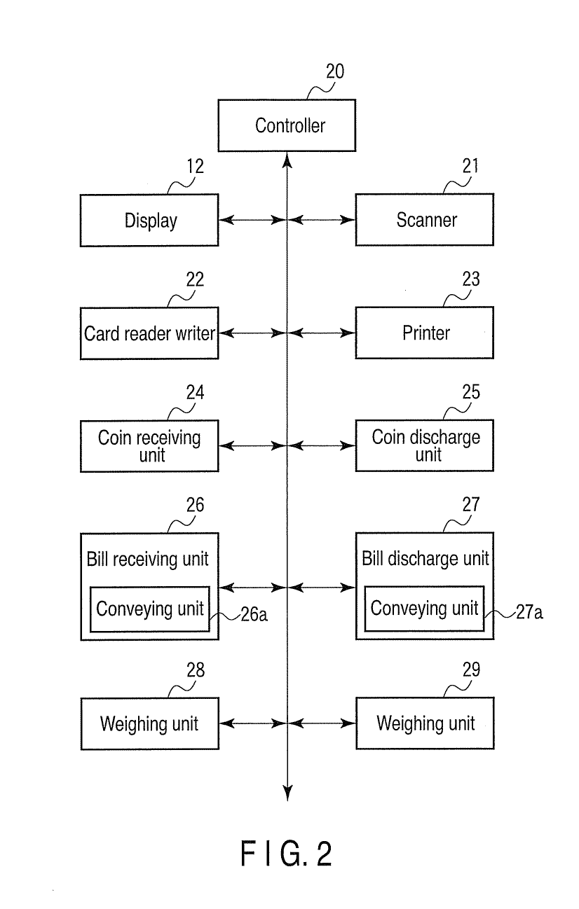

FIG. 2 is a block diagram of the apparatus 100. In FIG. 2, components same as those shown in FIG. 1 are denoted by the same reference numerals and detailed explanation of the components is omitted.

As shown in FIG. 2, the apparatus 100 includes a controller 20, a scanner 21, a card reader writer 22, a printer 23, a coin receiving unit 24, a coin discharge unit 25, a bill receiving unit 26, a bill discharge unit 27, and weighing units 28 and 29. Among these components, the controller 20, the scanner 21, the card reader writer 22, the printer 23, the coin receiving unit 24, the coin discharge unit 25, the bill receiving unit 26, and the bill discharge unit 27 are arranged on the inside of the housing 11. The weighing unit 28 is arranged on the inside of the commodity table 2. The weighing unit 29 is arranged on the inside of the commodity table 3.

The scanner 21, the card reader writer 22, the printer 23, the coin receiving unit 24, the coin discharge unit 25, the bill receiving unit 26, the bill discharge unit 27, the weighing unit 28, the weighing unit 29, and the like are connected to the controller 20 via a system bus or the like. The controller 20 includes a central processing unit (CPU), a read only memory (ROM), and a random-access memory (RAM). The CPU executes processing based on an operating system and an application program stored in the ROM and the RAM, whereby the controller 20 controls the sections in order to realize operations of the self-checkout apparatus.

The scanner 21 optically reads, via the scanner window 13, a barcode of a commodity held in front of the scanner window 13 by a customer.

The card reader writer 22 reads data recorded in a card inserted into the card insertion slot by the customer and writes data in the card. The card is a point card, an IC card for settlement, or the like.

The printer 23 prints a receipt. The receipt printed by the printer 23 is discharge from the receipt issue slot to the outside of the housing 11.

The coin receiving unit 24 applies processing such as check of genuineness, discrimination of a type, or counting to coins inserted into the coin insertion slot by the customer.

The coin discharge unit 25 discharges, from the coin discharge slot, coins returned to the customer as change or the like.

The bill receiving unit 26 receives bills inserted into the bill insertion slot and applies processing such as check of genuineness, discrimination of a type, or counting to the bills. In order to convey the bills inserted into the bill insertion slot to the inside of the housing 11, the bill receiving unit 26 includes a conveying unit 26a including a roller and a motor.

The bill discharge unit 27 discharges, from the bill discharge slot, bills returned to the customer as change or the like. Therefore, in order to convey the bills to the outside of the housing 11, the bill discharge unit 27 includes a conveying unit 27a including a roller and a motor.

The weighing unit 28 weighs commodities placed on the commodity table 2. In other words, the weighing unit 28 weighs unregistered commodities.

The weighing unit 29 weighs commodities placed on the commodity table 3. In other words, the weighing unit 29 weighs registered commodities.

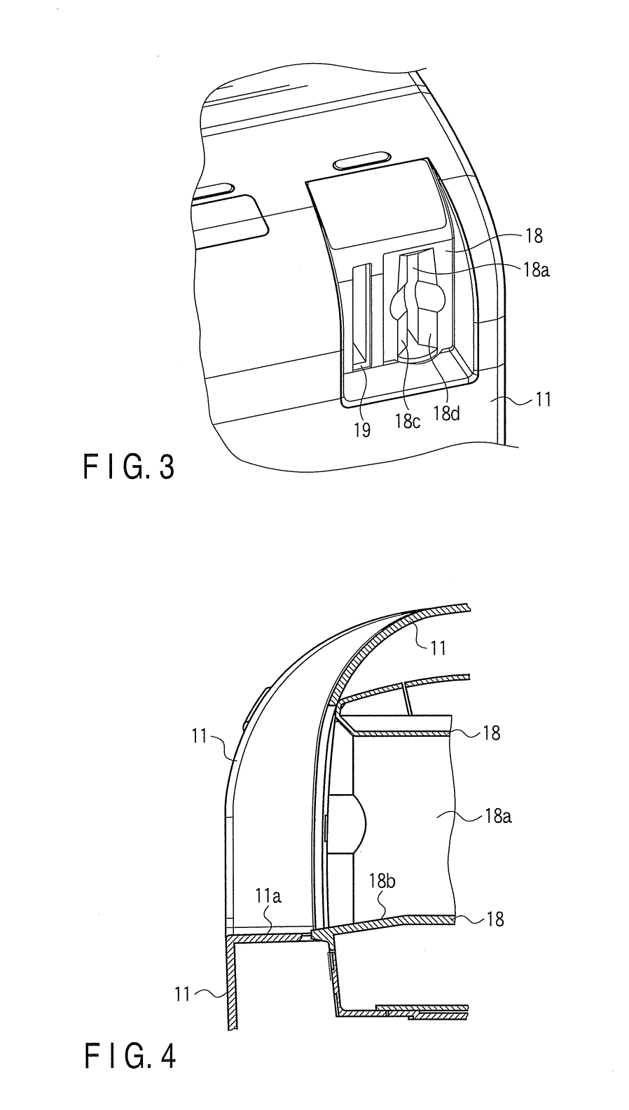

FIG. 3 is an enlarged perspective view of a part of the main body 1. FIG. 4 is a sectional view of the part of the main body 1. In FIGS. 3 and 4, components same as those shown in FIG. 1 are denoted by the same reference numerals.

As shown in FIGS. 3 and 4, the forming member 18 forms a vertically-long slit-like bill passage 18a. An opening of the bill passage 18a located on the outer side of the housing 11 is the bill insertion slot. The bill receiving unit 26 is arranged on the depth side of the bill passage 18a (the right side in FIG. 4). The bill receiving unit 26 receives, via the bill passage 18a, a bill inserted into the bill passage 18a by the customer.

The forming member 18 has three slopes 18b, 18c, and 18d to increase an opening area of the bill insertion slot.

The slope 18b is formed in a portion that forms a bottom surface of the bill passage 18a in the forming member 18. The slope 18b falls toward the outer side of the housing 11.

The slopes 18c and 18d are formed in portions that form sidewalls of the bill passage 18a in the forming member 18. The slopes 18c and 18d increase opening width in the horizontal direction of the bill passage 18a.

In the apparatus 100 configured as explained above, when the customer holds a purchased commodity in front of the scanner window 13, the scanner 21 reads a barcode of the purchased commodity. The controller 20 registers the purchased commodity using a commodity code indicated by the barcode read by the scanner 21. After all purchased commodities are registered, the customer inserts bills into the bill insertion slot or inserts coins into the coin insertion slot to pay a price.

When the customer inserts a bill into the bill insertion slot, the customer inserts, with short sides of the bill faced vertically, one of the short sides of the bill into the bill passage 18a from the bill insertion slot. If the leading of the bill shifts from the direction of the bill passage 18a because the bill curves in the thickness direction of the bill, the slopes 18c and 18d act to lead the leading of the bill to the bill passage 18a. This makes it easy to insert the bill from the bill insertion slot.

Since the bill insertion slot is a vertically-long opening, in the case of a customer unaccustomed to using the apparatus 100, it is likely that the customer misrecognizes the bill insertion slot as the coin insertion slot and inserts a coin into the bill insertion slot. In this case, since the bill insertion slot is the vertically-long opening, the coin is also inserted in the bill insertion opening in a standup state.

The coin inserted into the bill insertion lot by mistake in this way is discharged to the outside of the housing 11 with the own weight of the coin along the slope 18b. This makes it possible to prevent the coin inserted into the bill insertion slot by mistake from entering the inside of the housing 11.

Since the coin inserted into the bill insertion slot by mistake is inserted in the standup state as explained above, the circumferential surface of the coin comes into contact with the slope 18b. The coin rolls down the slope 18b. Therefore, the coin is surely discharged to the outside of the housing 11. It is unnecessary to set a tilt angle of the slope 18b very large. If the tilt angle of the slope 18b is small, the speed of the coin rolling down the slope 18b decreases. If a horizontal plane 11a is formed near the slope 18b as shown in FIG. 4, the discharged coin can be stopped on the horizontal plane 11a.

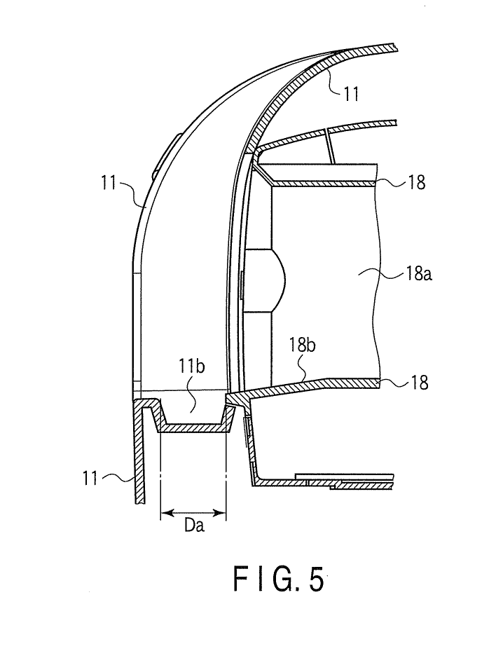

However, depending on a way of rolling of the coin, it is not unlikely that the coin falls down from the horizontal plane 11a because of inertia. Therefore, in order to surely prevent the discharged coin from dropping to a floor surface or the like, a saucer 11b may be formed near the slope 18b as shown in FIG. 5. In this way, it is possible to surely catch the discharged coin in the saucer 11b. In FIG. 5, a part of the housing 11 is bent to form the saucer 11b. However, a member having a saucer formed therein and separate from the housing 11 may be provided in a setting position of the saucer 11b shown in FIG. 5. The saucer may be formed integrally with the forming member 18.

It is desirable that one of inner wall surfaces of the saucer 11b is located right under an edge of the bill passage 18a or near the edge and a distance Da shown in FIG. 5 is larger than the outer diameter of a coin having a maximum size used in a region where the apparatus 100 is used. The distance Da is a distance from another inner wall surface opposed to the inner wall surface of the saucer 11b to the edge of the bill passage 18a.

Various modifications of this embodiment are possible as explained below.

Implementation same as the embodiment is possible not only in the self-checkout apparatus but also in any apparatus for performing money receipt such as an automatic change machine or a vending machine.

Implementation same as the embodiment is possible in a bill passage for discharging a bill with the bill discharge unit 27. However, even if a coin reaches the bill discharge unit 27, the bill discharge unit 27 does not receive the coin. Therefore, the bottom surface of the bill passage for discharging a bill may be kept as a horizontal plane without being formed as a slope.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A bill receiving apparatus comprising:
a housing;
a passage forming member configured to form a bill passage including a vertically-long slit-like opening and a bottom surface formed as a slope, a part of which falls toward the opening; and
a conveying unit provided on an inner side of the housing and configured to convey a bill via the bill passage.

2. The apparatus of claim 1, wherein the passage forming member forms the slope to reach the opening.

3. The apparatus of claim 1, further comprising a saucer provided near the opening and configured to receive a coin rolling to an outer side of the housing through the slope.

4. The apparatus of claim 3, wherein one of inner wall surfaces of the saucer is located right under an edge of the bottom surface or near the edge, and a distance from another inner wall surface opposed to the inner wall surface to the edge is larger than an outer diameter of a coin having a maximum size used in a region where the apparatus is used.

5. The apparatus of claim 1, further comprising:
a second passage forming member configured to form a second bill passage including a vertically-long slit-like second opening and a substantially horizontal bottom surface; and
a second conveying unit provided on the inner side of the housing and configured to convey the bill from the inner side to an outer side of the housing via the second bill passage, wherein
the conveying unit conveys the bill from the outer side to the inner side of the housing via the bill passage.

6. A self-checkout apparatus comprising:
a registering unit configured to register a purchased commodity according to operation by a purchaser;
a housing;
a passage forming member configured to form, between an inner side and an outer side of the housing, a bill passage including a vertically-long slit-like opening and a bottom surface formed as a slope, a part of which falls toward the opening; and
a conveying unit provided on the inner side of the housing and configured to convey, via the bill passage, a bill inserted into the bill passage by the purchaser as a price of the purchased commodity registered by the registering unit or a bill returned to the purchaser as change.

7. The apparatus of claim 6, wherein the passage forming member forms the slope to reach the opening.

8. The apparatus of claim 6, further comprising a saucer provided near the opening and configured to receive a coin rolling to the outer side of the housing through the slope.

9. The apparatus of claim 8, wherein one of inner wall surfaces of the saucer is located right under an edge of the bottom surface or near the edge, and a distance from another inner wall surface opposed to the inner wall surface to the edge is larger than an outer diameter of a coin having a maximum size used in a region where the apparatus is used.

10. The apparatus of claim 6, further comprising:
a second passage forming member configured to form a second bill passage including a vertically-long slit-like second opening and a substantially horizontal bottom surface; and
a second conveying unit provided on the inner side of the housing and configured to convey the bill, which is the change returned to the purchaser, from the inner side to the outer side of the housing via the second bill passage, wherein
the conveying unit conveys the bill inserted into the bill passage by the purchaser from the outer side to the inner side of the housing via the bill passage.
